(19) United States
(12) Patent Application Publication
(10) Pub. No.: US 2015/0040529 A1
(43) Pub. Date: Feb. 12, 2015

(54) Trimmer Attachment for a Riding Mower

(71) Applicant: Bobby G. Standridge, Cleveland, AL (US)

(72) Inventor: Bobby G. Standridge, Cleveland, AL (US)

(21) Appl. No.: 13/962,412

(22) Filed: Aug. 8, 2013

(51) Int. Cl. A01D 34/66; A01D 34/416

(52) U.S. Cl. CPC A01D 34/66; A01D 34/416
USPC 56/13.7; 56/229

(57) ABSTRACT

A weed and grass trimmer attachment and riding mowers having weed and grass trimmer attachments are provided. The trimmer attachment attaches to a riding mower using a structural support arm and a mounting member. The trimmer attachment takes power from the mower drive shaft to operate a trimmer attachment. The trimmer attachment includes a floating trimmer shaft that compensates for ground variations. The trimmer attachment enables a seated operator to both mow a lawn and trim grass and weeds.

### RELATED APPLICATIONS

There are no current related applications.

### FIELD OF THE INVENTION

The presently disclosed subject matter is directed to weed and grass trimmers. More particularly the disclosed subject matter is directed to trimmer attachments for riding mowers.

### BACKGROUND OF THE INVENTION

Americans spend countless hours maintaining and beautifying their lawns and landscape. Whether the property being maintained is residential, commercial, or industrial, as a matter of pride and personal expression Americans manicure their grass, plant and maintain flowers, shrubs, bushes, and trees, all for the sake of enhancing the aesthetic qualities of their property.

Lawn care is neither easy nor cheap. Good lawns can require turf, seeds, fertilizers, weed killers as well as an assortment of machinery and tools including lawnmowers, weed and grass trimmers, hoes, grass edgers, rakes, and shovels. American homeowners alone are reported to spend over six billion dollars ($6B) a year on lawn care, all to create a healthy expanse of green. Industrial and commercial interests may match that figure.

Proper lawn maintenance requires grass cutting. Because of the different types and sizes of properties many different lawn mowers have been developed. If there are large areas of grass to be cut zero turning radius riding mowers are very popular and highly effective. Such mowers allow their users to cut relatively large areas of grass in a minimal amount of time, while allowing the user to sit in comfort. More conventional riding lawn mowers remain popular, as do lawn tractors and other types of riding mowers.

While zero turning radius and other types of riding mowers are very useful they do have problems. Because of their rather large size, riding mowers are not very adept at cutting close to objects such as fences, buildings, trees, and the like. They can cut large areas of grass quickly, but they are ill-suited for fine lawn trimming As a result close cuts can require the user to return and use a string type trimmer This removes the benefits of saving time and being able to sit down.

In view of the foregoing there exists a need for a grass trimming attachment for riding lawn mowers. Preferably such an attachment would be well suited for use with conventional zero turning radius riding mower and could also be adapted for use with other types of conventional riding mowers, garden tractors and the like. Preferably such an attachment would enable a user to ride while trimming, would work around fences, trees, buildings and the like. Ideally such an apparatus would be highly configurable and could be attached to and removed from a wide range of lawn mowers using brackets. It would be beneficial if the trimmer mechanism itself could be electrically operated or run off a power take off (PTO). It would be useful if such and apparatus could be made available as a separate piece of riding equipment or as a kit.

### SUMMARY OF THE INVENTION

The principles of the present invention provide for trimming attachments for riding lawn mowers such as zero turning radius riding mowers, conventional riding mowers, garden tractors and the like. The inventive trimming attachments enable a user to ride while trimming around fences, trees, buildings and the like. The trimming attachments are highly configurable and can be attached to and removed from a wide range of lawn mowers using brackets. Suitable trimmer mechanisms include gas operated, electrically operated or power take off (PTO). The trimming attachments can be made available as separate pieces of riding equipment or a kit.

A trimmer attachment that is in accord with the present invention includes a trimmer head assembly having a structural support arm, a trimmer frame member, and a housing. A trimmer drive shaft rotatably extends through the housing and a trimmer drive pulley is attached to the trimmer drive shaft. A string plate is attached to the bottom of the trimmer drive shaft. The string plate is configured to receive string stock. The trimmer attachment also includes a multi-groove mower deck pulley for attaching to a mower drive shaft. In addition a trimmer drive belt for transferring rotation of the multi-groove mower deck pulley to the trimmer drive shaft is included.

In practice the housing is cylinder-shaped while the structural support arm includes mounting ears for attaching the structural support arm to the trimmer frame member. Preferably the multi-groove mower deck pulley has a center shaft aperture that is dimensioned to slide onto an existing mower deck drive shaft. In addition the trimmer drive belt may be a “V”-type belt.

The housing preferably includes a first bearing, a second bearing, and a vertical stop plate. In practice the trimmer drive shaft slides along the first bearing and the second bearing while the stop plate limits the distance the trimmer drive shaft slides. Beneficially the string plate has a convex bottom and/or a plurality of integral rings on an upper perimeter edge for receiving string stock.

A riding mower that is in accord with the present invention includes a mower frame having an operator's seat, wheels, and a steering control; and a mower deck attached to the mower frame, with the mower deck including a mower deck drive shaft. The riding mower further includes a trimmer head assembly having a structural support arm, a trimmer frame member, and a housing. A trimmer drive shaft rotatably extends through the housing and a trimmer drive pulley is attached to the trimmer drive shaft. A string plate is attached to the trimmer drive shaft. The string plate is configured to receive string stock. The riding mower also includes a multi-groove mower deck pulley attached to the mower deck drive shaft. In addition, a trimmer drive belt is disposed between the multi-groove mower deck pulley and the trimmer drive pulley.

In practice the housing is cylinder-shaped while the structural support arm includes mounting ears for attaching the structural support arm to the trimmer frame member. Preferably the multi-groove mower deck pulley has a center shaft aperture dimensioned to slide onto the existing mower deck drive shaft. In addition the trimmer drive belt may be a “V”-type belt.

The housing preferably includes a first bearing, a second bearing, and a vertical stop plate. In practice the trimmer drive shaft slides along the first bearing and the second bearing while the stop plate limits the distance the trimmer drive shaft slides. Beneficially the string plate has a convex bottom and/or a plurality of integral rings on an upper perimeter edge for receiving string stock.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front environmental view of a trimmer attachment 10 for a riding mower according to a preferred embodiment of the present invention;

FIG. 2 is a side environmental view of the trimmer attachment 10 shown in FIG. 1;

FIG. 3 is a perspective view of the trimmer attachment 10 shown in FIGS. 1 and 2; and,

FIG. 4 is a sectional view of a trimmer head assembly 20 of the trimmer attachment 10 taken along section line A-A of FIG. 3.

### DESCRIPTIVE KEY

10 trimmer attachment

20 trimmer head assembly

22 housing

24 trimmer drive shaft

26 trimmer drive pulley

28 string plate

30 trimmer drive belt

32a first bearing

32b second bearing

34 vertical stop plate

40 ring

42 string stock

50 support arm

52 mounting ear

60 mower deck pulley

62 shaft aperture

70 trimmer frame

72a first attachment ear

72b second attachment ear

80 fastener

82 fastener aperture

90 ground

100 riding mower

110 mower frame

115 mower deck

116 deck drive belt

120 front wheel

125 rear wheel

130 operator's seat

135 steering control means

140 deck drive shaft

### DETAILED DESCRIPTION OF THE PREFERRED EMBODIMENT

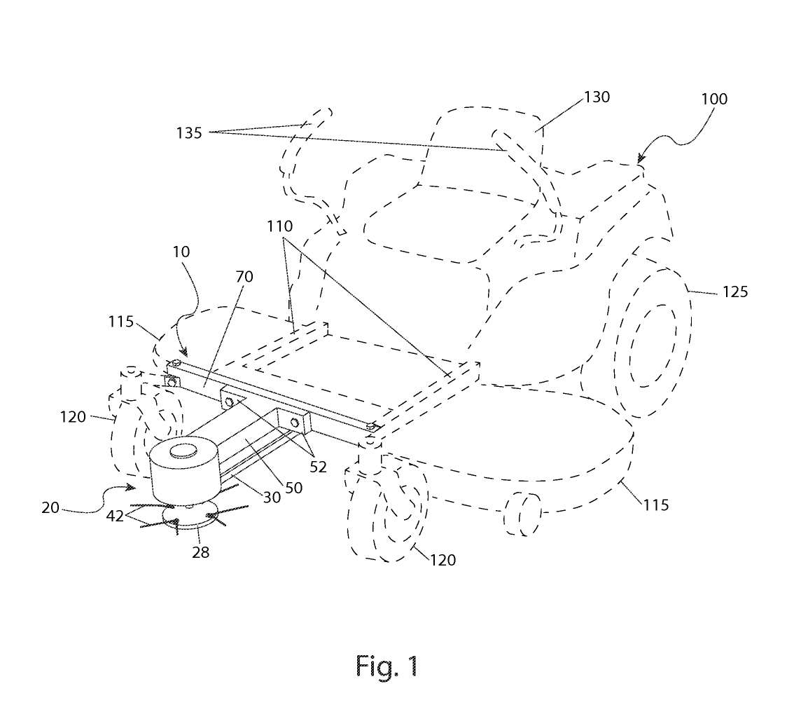

The best mode for carrying out the invention is presented in terms of its preferred embodiment, herein depicted within FIGS. 1 through 4. However, the invention is not limited to the described embodiment and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The terms “a” and “an” herein do not denote a limitation of quantity, but rather denote the presence of at least one of the referenced items.

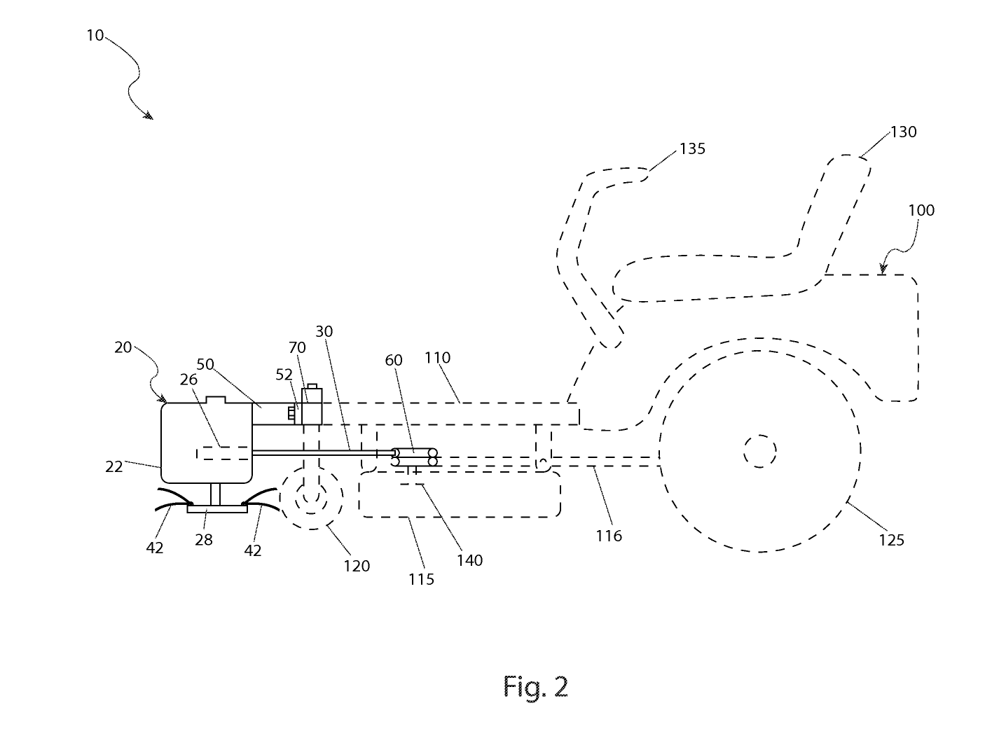

Referring now to FIGS. 1 and 2, respectively front and side environmental views of a trimmer attachment 10 that is in accord with the present invention on a riding mower 100. The trimmer attachment 10 enables an operator of the riding mower 100 to perform weed and grass trimming tasks while remaining seated on the riding mower 100.

The trimmer attachment 10 is envisioned as being introduced in several models for custom attachment to popular makes of riding mowers 100. The riding mower 100 is envisioned as being a conventional riding-type unit having generally expected features such as a mower frame 110, a mower deck 115, a pair of front wheels 120, a pair of rear wheels 125, an operator's seat 130, and steering control means 135.

The trimmer attachment 10 includes a forward protruding trimmer head assembly 20. The trimmer head assembly 20 is attached to a mower frame 110 of a riding mower 100 via a structural support arm 50 and trimmer frame 70 members. As shown, trimmer head assembly 20 is beneficially attached to the front center position of the riding mower 100. Preferably the trimmer frame 70 is mounted to the mower frame 110 using existing fasteners.

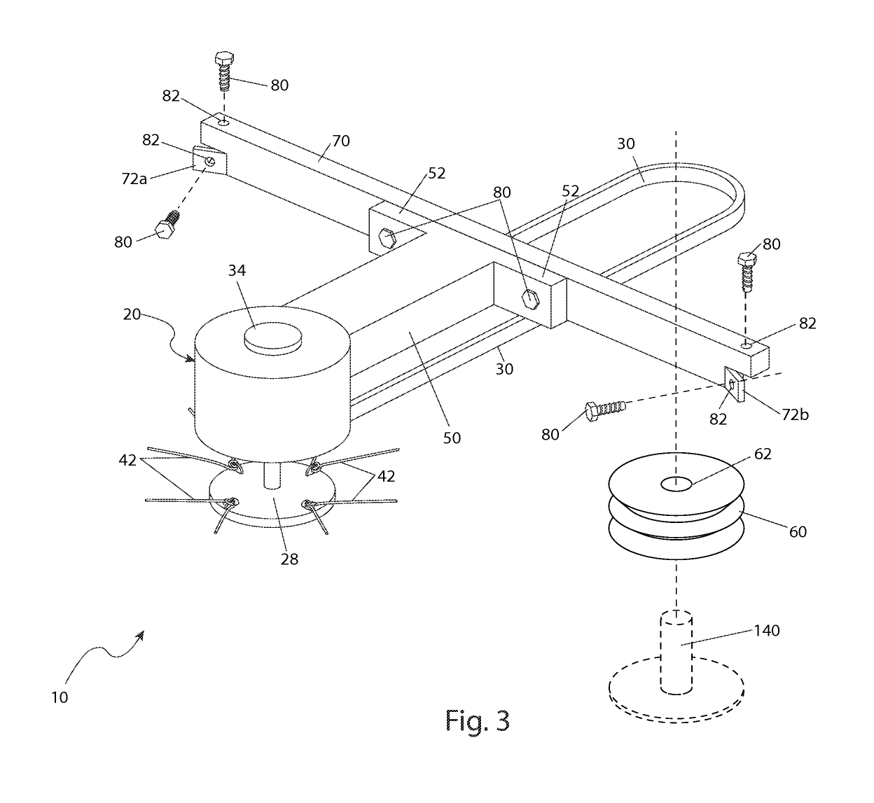

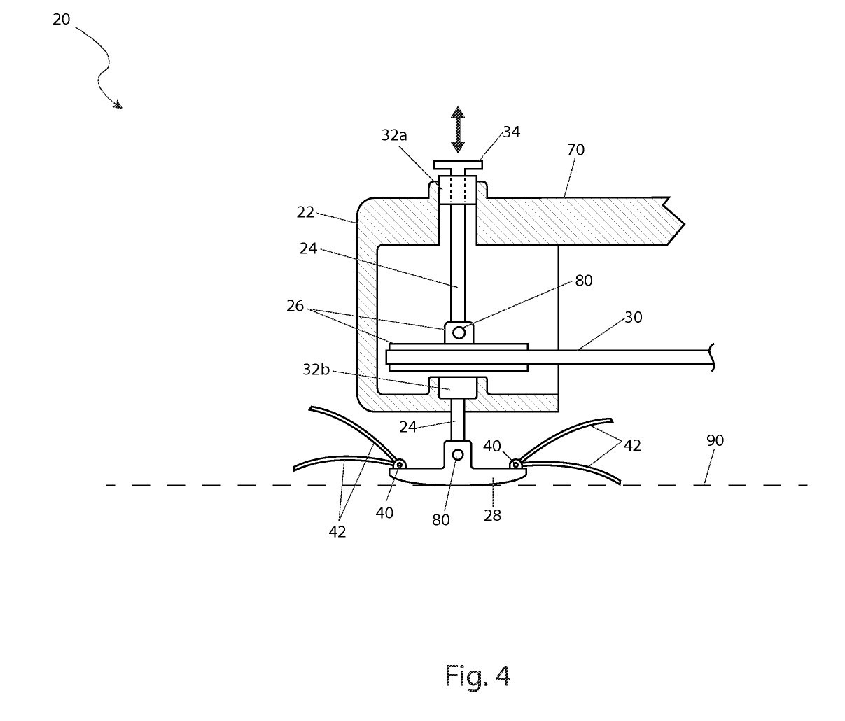

Referring now primarily to FIG. 4, the trimmer head assembly 20 includes a cylinder-shaped housing 22 which provides a protective enclosure for a trimmer drive shaft 24, a trimmer drive pulley 26, and a string plate 28. As best shown in FIG. 3, the trimmer drive pulley 26 is in mechanical communication with the existing mower deck 115 via a two-groove mower deck pulley 60 that is attached to a mower deck drive shaft 140. In practice, the mower deck pulley 60 replaces an original drive pulley of the mower deck 115. Referring now to FIGS. 3 and 4, a trimmer drive belt 30 is installed within grooves of the trimmer drive pulley 26 and the mower deck pulley 60. The trimmer drive belt 30 transfers the rotation of the mower deck pulley 60 to the trimmer drive pulley 26. The trimmer drive pulley 26 spins the string plate 28, which is also within the housing 22. The string plate 28 rotates the attached string stock 42 to perform trimming

Referring primarily to FIGS. 1 and 3, the trimmer attachment 10 supports cantilevered positioning of the trimmer head assembly 20 in the forward center position via the integral support arm 50. The support arm 50 includes a pair of opposing horizontal mounting ear 52 the enable removable attachment to a trimmer frame 70 using fasteners 80. The trimmer frame 70 is bolted to the forward mower frame 110 of the riding mower 100 using additional fasteners 80. It is envisioned that various configurations of the trimmer frame 70 would be made available for attaching to different models of riding mowers 100.

Referring now to FIG. 3, a perspective view of the trimmer attachment 10, the support arm 50 and the trimmer frame 70 are envisioned as being made of steel or aluminum rectangular structural tubing. The trimmer frame 70 is shown with fastener apertures 82 along a top surface as well as an integral first attachment ear 72a and an integral second attachment ear 72b that are located at opposing ends of the trimmer frame 70. The attachment ears 72a, 72b have fastener apertures 82. The fastener apertures 82 and the attachment ears 72a, 72b enable rigid attachment to the mower frame 110 of the riding mower 100, preferably by using existing fastening features such as bolts. It is envisioned that various configurations of the trimmer frame 70 would be introduced to fit different models of riding mowers 100.

Still referring primarily to FIG. 3, mechanical power is supplied to the mower deck 115 by the engine of the riding mower 100. The mechanical power is directed to the trimmer head assembly 20 by the two-groove mower deck pulley 60 which is located on the mower deck 115 in place of an original drive pulley. The two-groove mower deck pulley 60 has a center shaft aperture 62 that is dimensioned to slide onto an existing mower deck drive shaft 140 (shown in FIG. 2). The two-groove mower deck pulley 60 is connected to the trimmer head assembly 20 using the connecting “V”-type trimmer drive belt 30.

FIG. 4 presents a sectional view of the trimmer attachment 10 taken along section line A-A of FIG. 3. The trimmer head assembly 20 is envisioned as being made using machined or cast metal. The trimmer head assembly 20 provides a mounting attachment for drive components including the trimmer drive shaft 24, the trimmer drive pulley 26, the string plate 28, a first bearing 32a, a second bearing 32b, and a vertical stop plate 34.

The trimmer drive shaft 24 is a vertical rod that is slide into and laterally supported by the first bearing 32a and the second bearing 32b. This configuration allows the trimmer drive shaft 24 to float vertically. The first bearing 32a and the second bearing 32b are envisioned as being standard ball or roller type components that are positioned along a common vertical axis and then press-fit into the housing 22. The trimmer drive shaft 24 floats vertically within the bearings first bearing 32a and the second bearing 32b. This enables the trimmer head assembly 20 to adjust to ground 90 variations during operation.

The string plate 28 is attached to the bottom end of the trimmer drive shaft 24 via a fastener 80 such as a split pin, set screw, bolt, or the like. The string plate 28 provides an attachment for a trimming string stock 42. The string plate 28 is a circular member having a flat upper surface and a convex or spherical bottom surface that are designed to compliantly slide along the ground 90 while causing the affixed trimmer drive shaft 24 to float up and down. The trimmer drive shaft 24 further includes the integral disc-shaped vertical stop plate 34 which extends horizontally from an upper end of the trimmer drive shaft 24. The vertical stop plate 34 can contact the top of the housing 22 to limit a downward positioning of the trimmer drive shaft 24 as it moves vertically during operation.

The string plate 28 preferably includes a trimmer string tie having a plurality of integral rings 40 along an upper perimeter edge. This provides a mechanism to tie lengths of heavy-duty string stock 42. However, it should be understood that other string plate designs which utilize various types of trimming string securement and feeding mechanisms may be used.

In use, rotating torsion is applied to the trimmer drive shaft 24 via the trimmer drive pulley 26, which is attached to the trimmer drive shaft 24 using a fastener 80 such as a split pin, set screw, bolt, or the like. The trimmer drive pulley 26 is preferably a “V”-groove pulley that is driven by the trimmer drive belt 30 (see FIGS. 2 and 3).

It is envisioned that other styles and configurations of the present invention can be easily incorporated into the teachings of the present invention. While only one particular configuration is shown and described, that is for purposes of clarity and disclosure and not by way of limitation of scope.

The preferred embodiment of the present invention can be utilized by the common user in a simple and effortless manner with little or no training. After initial purchase or acquisition of the trimmer attachment 10, it would be installed as indicated in FIGS. 1 and 2.

The method of installing and using the trimmer attachment 10 may be achieved by: procuring a model of the trimmer attachment 10 having a trimmer frame 70 which fits on an existing riding mower 100; removing the existing drive pulley from the existing mower deck 115; installing the two-groove mower deck pulley 60 on the existing deck drive shaft 140; re-installing the existing deck drive belt 116 to a lower groove of the two-groove mower deck pulley 60; pre-assembling the trimmer head assembly 20 and integral support arm 50 to the trimmer frame 70; attaching the trimmer frame 70 to the existing mower frame 110, preferably utilizing existing fastener features of the mower frame 110, using provided fasteners 80; installing the trimmer drive belt 30 on the trimmer drive pulley 26 and on the upper groove of the mower deck pulley 60; tying a section of heavy-duty string stock 42 to each ring 40 of the string plate 28; operating the riding mower 100 in a normal manner; utilizing the controls of the existing riding mower 100 and mower deck 115 to activate and position the trimmer head assembly 20; utilizing the trimmer attachment 10 to trim grass and remove other unwanted growth upon the ground 90; and, benefiting from reduced effort while string trimming large or difficult areas afforded a user of the trimmer attachment 10.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. The embodiment was chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A trimmer attachment, comprising:
a trimmer head assembly, comprising:
a housing, including a first bearing, a second bearing, and a stop plate; and,
a support arm extending outwardly from a rear of said housing, further having two flanges;
a trimmer frame member rigidly fixed to said support arm flanges, said trimmer frame member configured to be rigidly attached to a mower frame;
a vertically movable trimmer drive shaft rotatably extending through said housing;
a trimmer drive pulley within said housing and attached to said trimmer drive shaft, said trimmer drive pulley vertically movable within said housing;
a string plate attached to the bottom of said trimmer drive shaft, said string plate for receiving string stock;
a multi-groove mower deck pulley for attaching to a mower drive shaft; and,
a trimmer drive belt for transferring rotation of said multi-groove mower deck pulley to said trimmer drive shaft;
wherein said stop plate is mounted to an upper distal end of said trimmer drive shaft external from said housing; and,
wherein said stop plate, when contacting a top surface of said housing, arrests downward travel of said trimmer drive shaft.

2. The trimmer attachment according to claim 1, wherein said housing is cylinder-shaped.

3. (canceled)

4. The trimmer attachment according to claim 1, wherein said multi-groove mower deck pulley has a center shaft aperture dimensioned to slide onto an existing mower deck drive shaft.

5. The trimmer attachment according to claim 1, wherein said trimmer drive belt is a “V”-type belt.

6. (canceled)

7. The trimmer attachment according to claim 1, wherein said trimmer drive shaft slides along said first bearing and said second bearing.

8. (canceled)

9. The trimmer attachment according to claim 8, wherein said string plate has a convex bottom.

10. The trimmer attachment according to claim 8, wherein said string plate includes a plurality of integral rings on an upper perimeter edge for receiving string stock.

11. A riding mower, comprising:
a mower frame having an operator's seat, wheels, and a steering control;
a mower deck attached to said mower frame, said mower deck including a mower deck drive shaft;
a trimmer head assembly, comprising:
a housing, including a first bearing, a second bearing, and a stop plate; and,
a support arm extending outwardly from a rear of said housing, further having two flanges;
a trimmer frame member rigidly fixed to said support arm flanges and rigidly attached to said mower frame;
a vertically movable trimmer drive shaft in said housing;
a trimmer drive pulley within said housing attached to said trimmer drive shaft, wherein said trimmer drive pulley is vertically movable within said housing;
a string plate attached to said trimmer drive shaft, said string plate for receiving string stock;
a multiple groove mower deck pulley attached to said mower deck drive shaft; and,
a trimmer drive belt disposed between said multi-groove mower deck pulley and said trimmer drive pulley;
wherein said stop plate is mounted to an upper distal end of said trimmer drive shaft external from said housing; and,
wherein said stop plate, when contacting a top surface of said housing, arrests downward travel of said trimmer drive shaft.

12. The riding mower according to claim 11, wherein said housing is cylinder-shaped.

13. (canceled)

14. The riding mower according to claim 11, wherein said multi-groove mower deck pulley has a center shaft aperture dimensioned to slide onto said mower deck drive shaft.

15. The riding mower according to claim 11, wherein said trimmer drive belt is a “V”-type belt.

16. (canceled)

17. The riding mower according to claim 11, wherein said trimmer drive shaft slides along said first bearing and said second bearing.

18. (canceled)

19. The riding mower according to claim 18, wherein said string plate has a convex bottom.

20. The riding mower according to claim 18, wherein said string plate includes a plurality of integral rings on an upper perimeter edge for receiving string stock.
